(19) United States
(12) Patent Application Publication
(10) Pub. No.: US 2025/0225085 A1
(43) Pub. Date: Jul. 10, 2025

(54) ROUTE LOOKUP IN A NETWORK DEVICE

(71) Applicant: Intel Corporation, Santa Clara, CA (US)

(72) Inventors: Kartik LAKHOTIA, San Jose, CA (US); Ankit GUPTA, Bangalore (IN); Karthik NARAYANAN, Keezhcherimel, Chengannur (IN); Yong ZHANG, Hillsboro, OR (US)

(21) Appl. No.: 19/090,250

(22) Filed: Mar. 25, 2025

(51) Int. Cl. G06F 13/16

(52) U.S. Cl. CPC G06F 13/16

(57) ABSTRACT

Examples described herein relate to a network interface device. In some examples, the network interface device is configured to determine routing information for a packet by: access a content addressable memory (CAM) to retrieve an Internet Protocol (IP) subnetwork identifier based on a portion of a destination address of the packet; determine a starting memory address of a subnetwork in a memory based on the subnetwork identifier; determine an offset from the starting memory address based on a second portion of the destination address; access the memory to retrieve the routing information for the packet based on the offset and the starting memory address.

Networks provide connectivity among multiple processors, memory devices, and storage devices for distributed performance of processes. In a network, forwarding elements forward packets to their destinations based on egress ports specified in routing tables. As the number of addressable destinations increase, a size of routing tables increases and memory utilized to store the routing tables increases and the memory may not have sufficient capacity to store the routing tables.

### BRIEF DESCRIPTION OF THE DRAWINGS

FIGS. 1A and 1B depict example forwarding elements.

FIG. 2 depicts an example network interface device.

FIG. 3 depicts an example of operations.

FIG. 4 depicts an example system.

FIGS. 5A and 5B depict example processes.

FIG. 6 depicts an example process.

FIG. 7 depicts an example computing system.

### DETAILED DESCRIPTION

In a network interface device (e.g., forwarding element, network interface device, or host system), to attempt to reduce an amount of content addressable memory utilized to store entries to determine routing information for a packet, various examples can access a routing table stored among multiple memory devices. The routing table architecture can be hierarchically designed to first query for a subnet identifier from a first memory and then query for a particular address within the identified subnet, from a second memory, to identify routing information for the packet. An IP subnetwork identifier can identify a portion of a larger IP network. To lookup routing information to forward a packet, various examples can lookup a hierarchy of entries stored in Content Addressable Memory (CAM) and static random access memory (SRAM), although other types of memory can be used. For example, a destination Internet Protocol (IP) address can be divided into multiple segments and different segments can be used for querying entries in memory devices. A CAM, or other type of memory, can store a subnetwork identifier for various destination IP addresses. A first segment of the destination IP address can be used to query the CAM to determine a subnet identifier for the packet. An SRAM, or other type of memory, can store routing information for devices of the subnetwork. A second segment of the destination IP address can be an offset from the subnet identifier and the offset and the subnet identifier can identify routing information for the packet in the SRAM or other type of memory. For example, routing information can include at least: an egress port, a sequence of egress ports, or a destination identifier used to identify a last hop forwarding element and compute an egress port path for the packet. Various examples can provide IP address based routing lookup and direct routing for both intra subnetwork and inter subnetwork forwarding of packets to a destination network interface device without using a gateway even if the destination network interface device is in a different subnet.

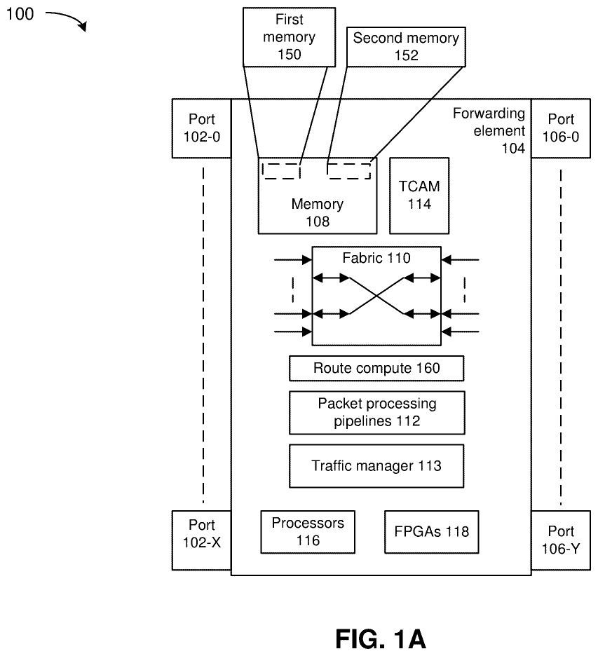

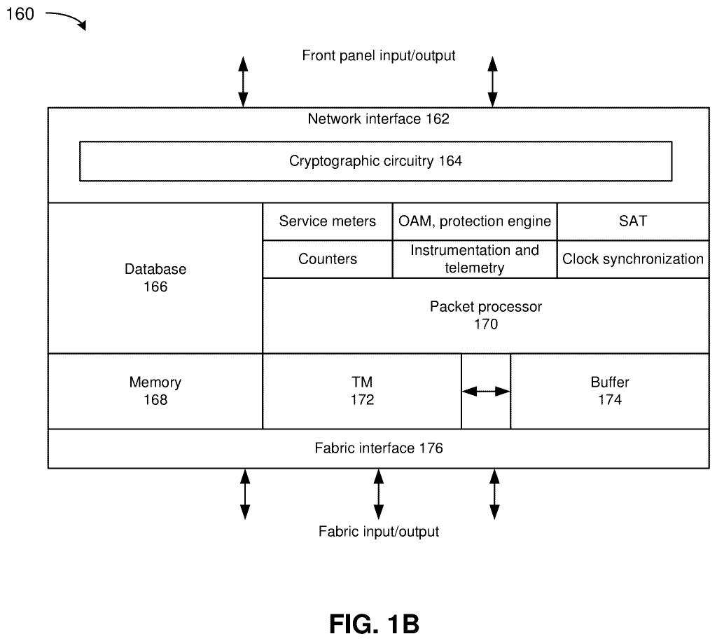

FIG. 1A depicts an example forwarding element. Various examples of forwarding element system 100 can be used to perform, for a packet, lookup of a subnet identifier from a first memory based on a portion of a packet identifier and routing information from a second memory based on the subnet identifier and an offset, as described herein. Forwarding element circuitry 104 can be communicatively coupled to one or more of ingress ports 102-0 to 102-X by interface circuitries and one or more of egress ports 106-0 to 106-Y by interface circuitries, where X and Y are integers. Forwarding element circuitry 104 can route packets, flits, or frames of any format or in accordance with any specification from one or more of ports 102-0 to 102-X to one or more of ports 106-0 to 106-Y (or vice versa). One or more of ports 102-0 to 102-X can be connected to a network of one or more interconnected devices, including a network interface device. Similarly, one or more of ports 106-0 to 106-Y can be connected to a network of one or more interconnected devices, including a network interface device.

In some examples, switch fabric 110 can provide routing of packets from one or more ingress ports 102-0 to 102-X for processing prior to egress from forwarding element 104 via one or more of ports 106-0 to 106-Y. Switch fabric 110 can be implemented as one or more multi-hop topologies, where example topologies include torus, butterflies, buffered multi-stage, shared memory switch fabric (SMSF), among other implementations. SMSF can be a switch fabric connected to ingress ports and egress ports in the switch, where ingress subsystems write (store) packet segments into the fabric's memory, while the egress subsystems read (fetch) packet segments from the fabric's memory.

Memory 108 can be configured to store packets received at ingress ports 102-0 to 102-X prior to egress from one or more of ports 106-0 to 106-Y as well as device configuration information or other data. For example, memory 108 can include first memory 150 (e.g., CAM, Ternary Content-Addressable Memory (TCAM), SRAM, or other types of volatile or non-volatile memory). First memory 150 can store a first level of a routing table, which indicates a subnet of a packet identifier of a packet (e.g., destination IP address). Route compute circuitry 160 can query first memory 150 to match a destination subnet prefix, which can be of variable length, and can be obtained by masking a portion of the packet identifier. In some examples, first memory 150 can return the base address of subnet entries A_{sub} in the next level of the routing table, stored in a second memory. For example, A_{sub} can be a starting memory address in second memory 152 that stores routing information for the packet identifier to its destination.

Second memory 152 can store a next level of the routing table structure. If the ID of the port within the subnet is i, then route compute circuitry 160 can query second memory 152 with address A_{sub}+i and second memory 152 can return a routing path to the endpoint port. Note that even if the destination subnet is different from the source subnet, route compute circuitry 160 can query the path for the destination port directly without having to route via a gateway. If the destination subnet covers N_{sub} ports, then a subnet occupies N_{sub} entries in second memory 152. For direct routing to endpoint ports within a cluster, the number of entries in second memory 152 can be of the order of the number of endpoint ports in the cluster.

Packet processing pipelines 112 can include ingress and egress packet processing circuitry to respectively process ingressed packets and packets to be egressed. Packet processing pipelines 112 can determine which port to transfer packets or frames to using a table that maps packet characteristics with an associated output port. Packet processing pipelines 112 can be configured to perform match-action on packets to identify packet processing rules and next hops using information stored in a ternary content-addressable memory (TCAM) tables or exact match tables in some examples. For example, match-action tables or circuitry can be used whereby a hash of a portion of a packet is used as an index to find an entry (e.g., forwarding decision based on a packet header content). Packet processing pipelines 112 can implement access control list (ACL) or packet drops due to queue overflow.

Packet processing pipelines 112, processors 116, and/or FPGAs 118 can process received packet data by performing one or more of: summation of packet data with other packet data from other workers, multiplication, division, minimum, maximum, or other data computation operations related to reduce, AllReduce, ReduceScatter, or AllGather. Reduce can reduce the elements of an array into a single result. AllReduce can include collecting data from different processing units and combining the data into a result. ReduceScatter can reduce input values across ranks, with each rank receiving a subpart of the result. AllGather can aggregate A values into an output of dimension A*B, where B is an integer.

Configuration of operation of packet processing pipelines 112, including its data plane, can be programmed using Programming Protocol-independent Packet Processors (P4), C, Python, Broadcom Network Programming Language (NPL), or x86 compatible executable binaries or other executable binaries.

Traffic manager 113 can perform hierarchical scheduling and transmit rate shaping and metering of packet transmissions from one or more packet queues. Traffic manager 113 can perform congestion management such as flow control, congestion notification message (CNM) generation and reception, priority flow control (PFC), and others.

In some examples, forwarding element 100 can include one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU). An edge processing unit (EPU) can include a network interface device that utilizes processors and accelerators (e.g., digital signal processors (DSPs), signal processors, or wireless specific accelerators for Virtualized radio access networks (vRANs), cryptographic operations, compression/decompression, and so forth). In some examples, network interface device, switch, router, and/or receiver network interface device can be implemented as one or more of: one or more processors; one or more programmable packet processing pipelines; one or more accelerators; one or more application specific integrated circuits (ASICs); one or more field programmable gate arrays (FPGAs); one or more memory devices; one or more storage devices; or others. In some examples, router and switch can be used interchangeably. In some examples, a forwarding element or forwarding device can include a router and/or switch.

FIG. 1B depicts an example forwarding element (e.g., switch chip or router chip). Various examples can be used in or with forwarding element 100 to perform, for a packet, lookup of a subnet identifier from a first memory based on a packet identifier and routing information from a second memory based on the subnet identifier and an offset, as described herein. Forwarding element 160 can include a network interface 160 that can provide an Ethernet consistent interface. Forwarding element 160 can support for 25 GbE, 50 GbE, 100 GbE, 200 GbE, 400 GbE Ethernet port interfaces. Cryptographic circuitry 164 can perform at least Media Access Control security (MACsec) or Internet Protocol Security (IPSec) decryption for received packets or encryption for packets to be transmitted.

Various circuitry can perform one or more of: service metering, packet counting, operations, administration, and management (OAM), protection engine, instrumentation and telemetry, and clock synchronization (e.g., based on IEEE 1588).

Database 166 can store a device's profile to configure operations of switch 160. Memory 168 can include High Bandwidth Memory (HBM) for packet buffering. Packet processor 170 can perform one or more of: decision of next hop in connection with packet forwarding, packet counting, access-list operations, bridging, routing, Multiprotocol Label Switching (MPLS), virtual private LAN service (VPLS), L2VPNs, L3VPNs, OAM, Data Center Tunneling Encapsulations (e.g., VXLAN and NV-GRE), or others. Packet processor 170 can include one or more FPGAs. Buffer 174 can store one or more packets. Traffic manager (TM) 172 can provide per-subscriber bandwidth guarantees in accordance with service level agreements (SLAs) as well as performing hierarchical quality of service (QoS). Fabric interface 176 can include a serializer/de-serializer (SerDes) and provide an interface to a switch fabric.

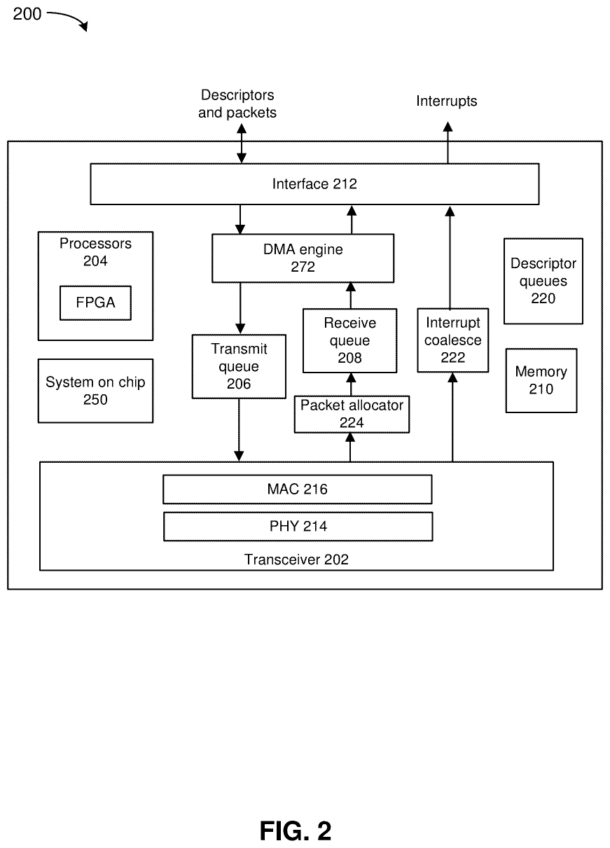

FIG. 2 depicts an example network interface device. In some examples, circuitry of network interface device (e.g., at least processors 204 or system on chip (SoC) 250) can perform, for a packet, lookup of a subnet identifier from a first memory based on an identifier of the packet and lookup of routing information from a second memory based on the subnet identifier and an offset, as described herein. In some examples, network interface device 200 can be implemented as a network interface controller, network interface card, a host fabric interface (HFI), or host bus adapter (HBA), and such examples can be interchangeable. Network interface device 200 can be coupled to one or more servers using a bus, PCIe, CXL, or Double Data Rate (DDR). Network interface device 200 may be embodied as part of a system-on-a-chip (SoC) that includes one or more processors, or included on a multichip package that also contains one or more processors.

Some examples of network interface device 200 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface device 200 can include transceiver 202, processors 204, transmit queue 206, receive queue 208, memory 210, and bus interface 212, and DMA engine 252. Transceiver 202 can be capable of receiving and transmitting packets in conformance with the applicable protocols such as Ethernet as described in IEEE 802.3, although other protocols may be used. Transceiver 202 can receive and transmit packets from and to a network via a network medium (not depicted). Transceiver 202 can include PHY circuitry 214 and media access control (MAC) circuitry 216. PHY circuitry 214 can include encoding and decoding circuitry (not shown) to encode and decode data packets according to applicable physical layer specifications or standards. MAC circuitry 216 can be configured to assemble data to be transmitted into packets, that include destination and source addresses along with network control information and error detection hash values.

Processors 204 can perform operations of a route compute unit that access a first memory to retrieve a subnetwork identifier based on a portion of an identifier of a packet, determine a starting memory address of the subnetwork in a memory based on the subnetwork identifier; determine an offset from the starting memory address based on a second portion of the destination address; and access the memory to retrieve routing information for the packet based on the offset and the starting memory address, as described herein. The routing information can be populated by firmware and can be changed during the runtime.

Processors 204 can be any a combination of a: processor, core, graphics processing unit (GPU), field programmable gate array (FPGA), application specific integrated circuit (ASIC), or other programmable hardware device that allow programming of network interface 200. For example, a “smart network interface” can provide packet processing capabilities in the network interface using processors 204.

Processors 204 can include one or more packet processing pipeline that can be configured to perform match-action on received packets to identify packet processing rules and next hops using information stored in a ternary content-addressable memory (TCAM) tables or exact match tables in some embodiments. For example, match-action tables or circuitry can be used whereby a hash of a portion of a packet is used as an index to find an entry. Packet processing pipelines can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping). For example, packet processing pipelines can implement access control list (ACL) or packet drops due to queue overflow.

Configuration of operation of processors 204, including its data plane, can be programmed based on one or more of: Protocol-independent Packet Processors (P4), Software for Open Networking in the Cloud (SONiC), Broadcom® Network Programming Language (NPL), NVIDIA® CUDA®, NVIDIA® DOCA™, Infrastructure Programmer Development Kit (IPDK), among others.

Packet allocator 224 can provide distribution of received packets for processing by multiple CPUs or cores using timeslot allocation described herein or RSS. When packet allocator 224 uses RSS, packet allocator 224 can calculate a hash or make another determination based on contents of a received packet to determine which CPU or core is to process a packet.

Interrupt coalesce 222 can perform interrupt moderation whereby network interface interrupt coalesce 222 waits for multiple packets to arrive, or for a time-out to expire, before generating an interrupt to host system to process received packet(s). Receive Segment Coalescing (RSC) can be performed by network interface 200 whereby portions of incoming packets are combined into segments of a packet. Network interface 200 provides this coalesced packet to an application.

Direct memory access (DMA) engine 252 can copy a packet header, packet payload, and/or descriptor directly from host memory to the network interface or vice versa, instead of copying the packet to an intermediate buffer at the host and then using another copy operation from the intermediate buffer to the destination buffer.

Memory 210 can be any type of volatile or non-volatile memory device and can store any queue or instructions used to program network interface 200. Transmit queue 206 can include data or references to data for transmission by network interface. Receive queue 208 can include data or references to data that was received by network interface from a network. Descriptor queues 220 can include descriptors that reference data or packets in transmit queue 206 or receive queue 208. Bus interface 212 can provide an interface with host device (not depicted). For example, bus interface 212 can be compatible with PCI, PCI Express, PCI-x, Serial ATA, and/or USB compatible interface (although other interconnection standards may be used).

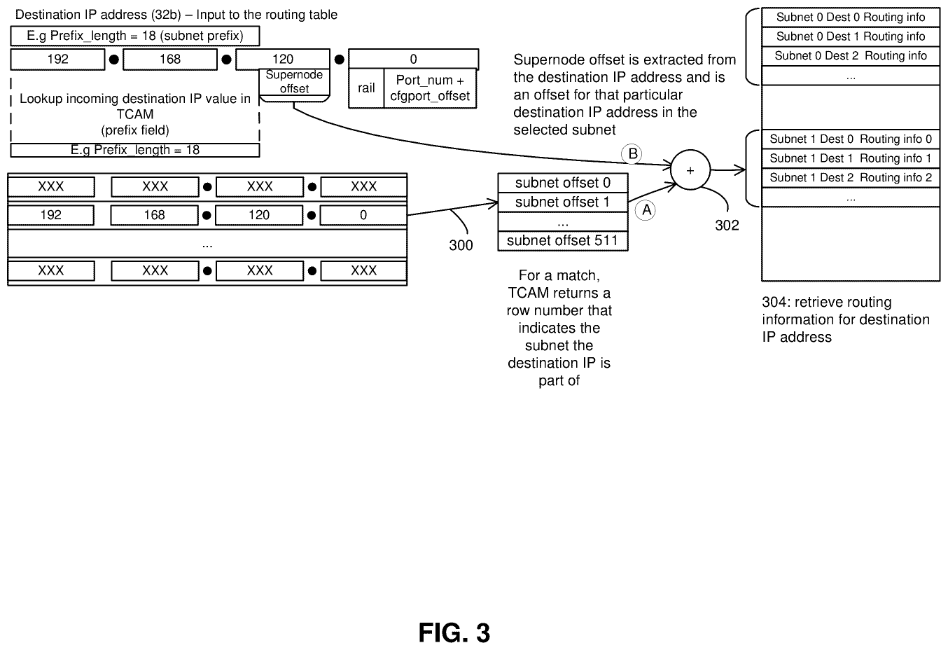

FIG. 3 depicts an example of operations. In some examples, a packet identifier such as a destination IP address can be used to determine a next hop or egress port for a packet. Ethernet uses Media Access Control (MAC) addresses and InfiniBand uses local identifiers (IDs) for routing within subnets. However, instead of a destination IP address, a 128-bit wide Global Identifier and/or a 16-bit local identifier can be used to identify an egress port (or the network adapter connected to the port) from which to egress the packet. For example, Ethernet destination Internet Protocol (IP) addresses that are IPV4 (32-bits wide) or IPV6 (128-bits wide) and a 48-bit MAC address can be used to identify an egress port from which to egress the packet.

Entries or rows in the CAM or TCAM can correspond to particular subnets. A subnet can be identified by a segment of a packet identifier. A prefix of the destination IP address of devices in the subnet can be obtained by masking some of the bits from the destination IP address. The use of subnets with prefix aggregation can divide the routing information into: (1) switching between devices in the same subnet whereby the routing path is obtained by querying an intra-subnet routing table or (2) routing across different subnets, whereby the routing path is obtained by querying an inter-subnet routing table. Note that routing within a subnet can also include switching for Ethernet packets. Datacenter companies and cloud service providers may allocate subsets of nodes to clients (e.g., tenants). Tenants can control IP address allocation and may have overlapping address spaces with other tenants. A cluster may support tenants simultaneously with an arbitrary number of nodes per tenant. However, packets from one tenant should not be routed to another tenant. Some platforms may attach a virtual local area network (VLAN) tag to the packets to distinguish tenants. The routing tables can be replicated for multiple VLANs or their keys are extended with VLAN Tags to allow different tenants to have their own address spaces and routing paths.

CAMs can match input a query against stored entries in a single clock cycle. A parallel matching operation allows CAMs to address spaces with low-latency querying. Ternary CAMs (TCAMs) can support a don't care bit (‘x’), which allows variable length prefix matching for routing across subnets of different sizes. A subnet part of the IP address can be used for matching, while the remaining lower destination IP address bits can be set to ‘x’. For an example IP address of 10.1.2.5, a subnet can be 10.1.2.x.

For example, at 300, in a first lookup operation, the circuitry of the forwarding element can query a CAM or TCAM to match against a subnet prefix segment of the destination IP address (or other identifier) of the received packet. In the CAM or TCAM, a unique sequence of values can be assigned to different subnets. The subnet prefix can include a number of bits of the destination IP address, which can be obtained by masking the destination IP address. In some examples, prefix length is different for queries of the CAM or TCAM and a parallel look up in the CAM or TCAM can be performed for different segments of the destination IP address. If a prefix field of the destination IP address matches the prefix field of a CAM or TCAM row, the corresponding row can be returned as a hit and indicate that the destination IP is part of a subnet associated with the corresponding row. At 300, the CAM or TCAM can provide a pointer to a location where the entries for the destination subnet are stored at an offset from a starting address in the SRAM. The CAM or TCAM can return a row number with content that exactly matches the prefix bits key and indicates the subnet the destination IP is part of. In other words, a segment of the destination IP address can be used as a key to retrieve a row value in a CAM or TCAM that matched the key. The row value can identify a subnet associated with destination IP address in the SRAM.

Routing information in the SRAM can include a list of routing information (e.g., path, hops, etc.) corresponding to destinations in the network. Routing information in the SRAM can be organized into groups corresponding to different subnets. The subnet locations need not be contiguous or in order.

At 302, an offset can be added to the subnet identifier to determine an SRAM address which stores the routing path to the destination IP address. For example, the offset can include lower significant bits of the destination IP address, not included in the subnet prefix. The offset can be an offset for a particular destination IP address in the selected subnet. One or more lower significant bits of the destination IP address can be added to the row number to determine an SRAM address which stores the routing path to the destination IP address. For example, bits 19-25 of the destination IP address can indicate an offset.

For example, 302 can include performing A+B, where A represents the row number of the subnet retrieved from the CAM or TCAM and B represents certain remaining bits in the destination IP address. The sum of A and B can represent a specific row in a subnet associated with the destination IP address. Address translation can be performed to determine an address in SRAM associated with the specific row in a subnet associated with the destination IP address.

At 304, routing information can be retrieved from the SRAM based on the address determined from the address translation. Routing information can include one or more of: a list of routing information (e.g., egress port sequence, number of hops, etc.) corresponding to a packet identifier. The subnet address locations need not be contiguous or in order. In source-routed networks, a routing table data structure stored in SRAM can be populated for the resources allocated to the tenant who is assigned the source port to maintain tenant isolation. In destination-routed networks, the destination IP address can be converted to global node/port ID at the source port and the ID can be used for routing by forwarding elements. For destination routing, the forwarding elements can determine a forwarding path based on a packet identifier of a packet, instead of the source specifying the route through a list of hops.

For example, for an IPv4 address 192.168.120.23/24, where the 24 most significant bits (MSBs) are subnet prefix and the remaining 8 least significant bits (LSBs) are a port address within the subnet. This subnet spans the address range 192.168.120.0 to 192.168.120.255. The subnet has a prefix 192.168.120.xx and the port has an ID=23 (offset) within this subnet. The TCAM at the first level returns the base address A_{sub} for SRAM where the path to IP address 192.168.120.0 is stored. This subnet occupies at most 2⁸=256 entries in the SRAM. The SRAM can be queried with address A_{sub}+23 which returns the direct routing path to destination 192.168.120.23.

Another level of lookup can be added to a hierarchy to reduce a size of SRAM utilized to store routing information. If there are at most 2^{x} endpoints connected to a forwarding element, then x lowest significant bits (LSBs) of the destination IP address can be used to indicate the port on the forwarding element connected to the destination port. The SRAM can return a path to the forwarding element, and the last ejection port to the destination can be directly obtained from the x LSBs. This reduces the address bits into SRAM and consequently, the size of the SRAM required, by a factor of 2^{x}. However, this also adds a constraint that the endpoints connected to a switch should have IP addresses that only differ in the x LSBs. The SRAM may also return a string of 2^{x} bits to specify if a certain port belongs to the destination subnet or not to maintain tenant isolation and ensure that packets from a tenant are not delivered to other tenants. If required, a port translation table can be used for flexible mapping of switch ports to the x LSBs.

For example, if the destination IP address is 192.168.121.23/24, then the subnet prefix is 192.168.121.xx. The CAM can be queried with the destination IP address and searches for a match with the subnet prefix. The CAM then returns the base address A_{sub} where routing path to the first entry of the subnet is stored. The middle 5 bits can be used to identify the destination switch within this subnet are 5′b00010. Route compute circuitry can query the SRAM with address A_{sub}+5′b00010, which returns the network path to the switch connected to the destination port. The last ejection port on this switch can be identified by the 3 LSBs whose value is 3′b111. Accordingly, a subnet occupies 32 entries in the SRAM, instead of 256 entries in the SRAM in the prior example.

For example, assuming that a forwarding element connects to at most 6 endpoints. In this case, the 24 MSBs are the subnet prefix and the 3 LSBs are used to identify the ejection port. The remaining 5 bits can be used to compute the query address into the SRAM to lookup the routing path to the destination. Therefore, this subnet only occupies 32 entries in the SRAM compared to 256 entries previously.

Accordingly, a single subnet covering a cluster can be supported without increasing the size of the CAM or TCAM. Various examples can reduce area, power and complexity of routing table in forwarding elements in clusters, datacenters, or cloud environments. Packets can be delivered directly to a destination network device without use of a gateway, even if the source and destination are in different subnets.

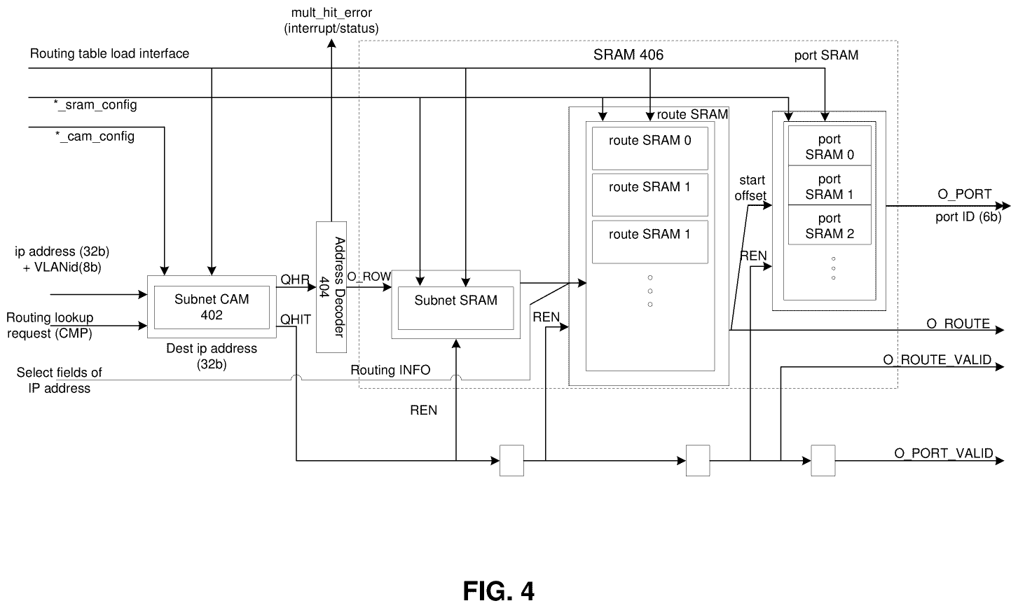

FIG. 4 depicts an example system. The system can be used in a route compute unit in a forwarding element or network interface device to determine a route for a packet. For example, based on a first segment of a packet identifier (e.g., destination IP address, global identifier, and/or MAC address), subnet CAM 402 can identify a subnet for a packet. Based on the identified subnet, address decoder 404 can determine a starting memory address for the subnet. An offset from the starting memory address can be added to the starting memory address, where the offset is based on a second segment of the packet identifier (e.g., offset). In SRAM 406, routing information can be obtained for the packet. Routing information can include egress port or sequence of egress ports to traverse (if source routing is used) or a network ID of the destination. In some examples, subnet CAM 402 can store a key for a subnet in a hash table and SRAM 406 can store a subnet identifier for a matched key. In some examples, SRAM 406 can include multiple memory devices that store one or more of: a route information and port information.

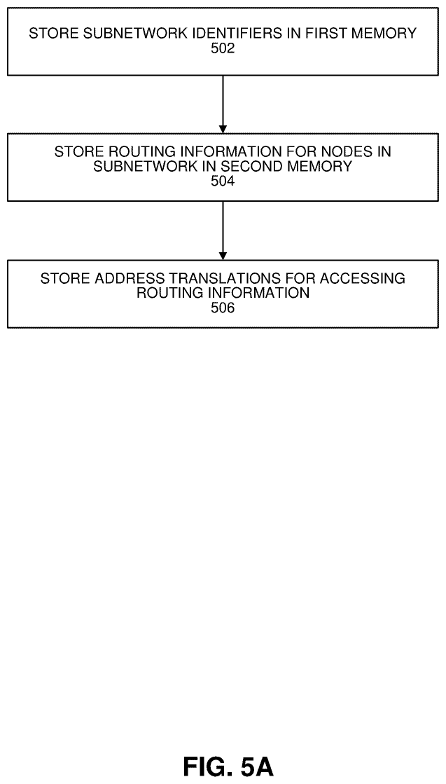

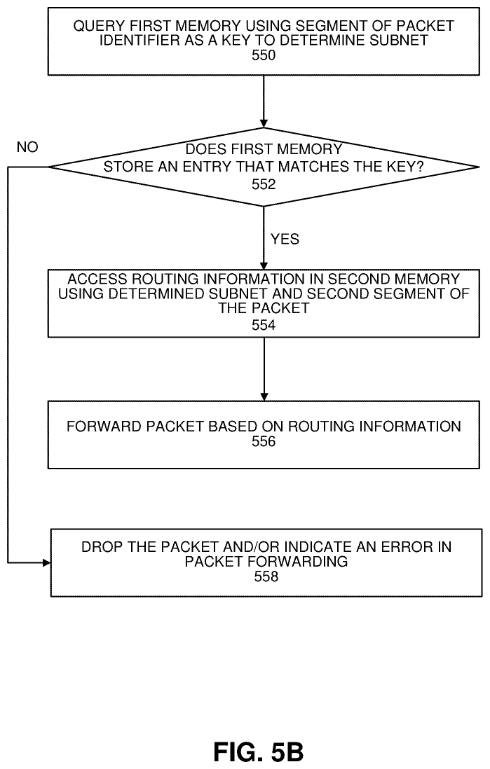

FIG. 5A depicts an example process. The process can be performed by an orchestrator, forwarding element, or network interface device in some examples. At 502, entries of a first memory can be configured to store subnet identifiers for different packet identifier values. The first memory can include a CAM or TCAM. Packet identifier values can be based on a segment of destination IP addresses, global identifiers, and/or MAC addresses. At 504, entries of a second memory can be configured to store routing information for packets associated with offsets within subnets. The second memory can include an SRAM or other memory. For example, routing information for destinations with a subnet can be stored in the second memory starting at a memory address based on the subnet identifier. A routing information for a particular destination can be determined based on a translation of an offset to a memory address offset. In some examples, different offsets within a subnet can be stored in contiguous or noncontiguous memory addresses. At 506, a lookup table or address decoder can be programmed to identify the memory addresses corresponding to different subnets and different offsets within different subnets.

FIG. 5B depicts an example process. The process can be performed by a forwarding element or network interface device based on receipt of a packet in some examples. At 550, a first segment of a packet identifier for the received packet can be used to query a first memory to determine a subnet associated with the received packet. The first memory can include a CAM or TCAM. At 552, a determination can be made if the subnet identifier is stored in the first memory for the first segment of the packet identifier. Based on a subnet identifier being stored in the first memory for the first segment of the packet identifier, the process can proceed to 554. Based on a subnet identifier not being stored in the first memory for the first segment of the packet identifier, at 560, the process can drop the packet and/or indicate an error to an orchestrator and/or host system. At 554, a memory address in a second memory can be determined based on the subnet identifier and an offset. The second memory can include an SRAM or other memory. The memory address in the second memory can be retrieved from a memory address decoder or look up table in some examples. At 556, based on the determined memory address, routing information for the retrieved packet can be accessed. At 558, the packet can be routed based on the retrieved routing information.

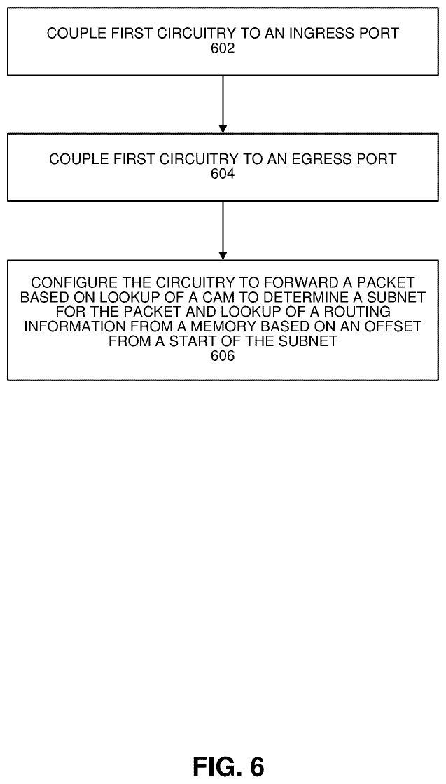

FIG. 6 depicts an example process to form a forwarding element. At 602, a first circuitry can be connected to an ingress port. At 604, the first circuitry can be connected to an egress port. At 606, based on a packet to be forwarded, the circuitry can be configured to determine routing information of a packet based on retrieving a subnetwork identifier by querying a CAM and accessing a memory to retrieve the routing information based on the subnetwork identifier and an offset.

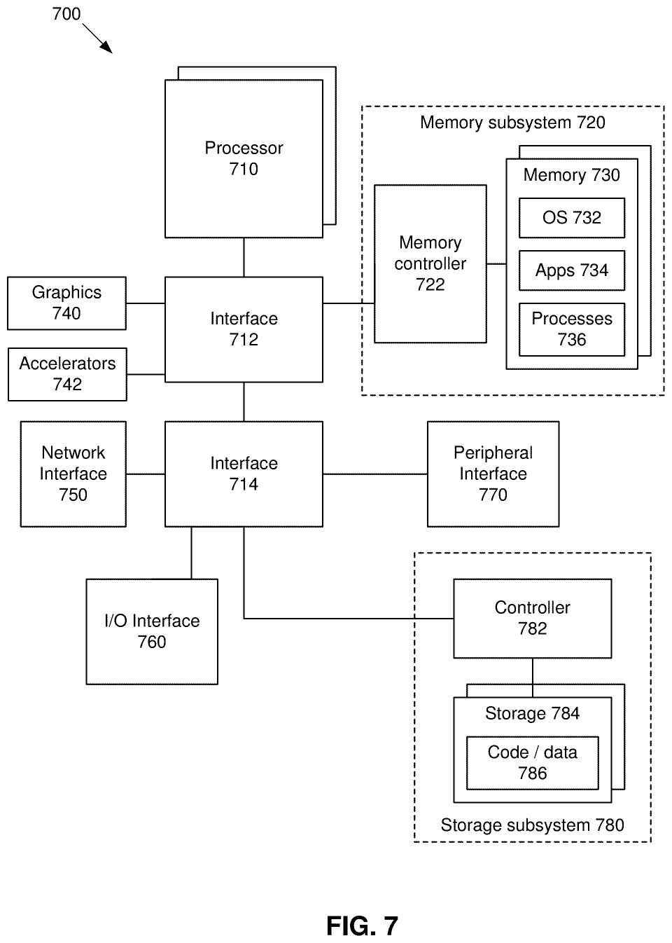

FIG. 7 depicts a system. The system can use examples to configure a network interface device to query a first memory to determine a subnet of a packet based on a packet identifier and query a second memory to determine routing information based on the subnet and an offset from a start of routing information for the subnet, as described herein. In some examples, processor 710, graphics 740, one or more of accelerators 742, and/or network interface 750 can decompress or decrypt data and store an entirety of decompressed or decrypted data or a strict subset of decompressed or decrypted data or validate decompression or decryption operations, described herein. System 700 includes processor 710, which provides processing, operation management, and execution of instructions for system 700. Processor 710 can include any type of microprocessor, central processing unit (CPU), graphics processing unit (GPU), processing core, or other processing hardware to provide processing for system 700, or a combination of processors. Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die.

Accelerators 742 can be a fixed function or programmable offload engine that can be accessed or used by a processor 710. For example, an accelerator among accelerators 742 can provide data compression (DC) capability, cryptography services such as public key encryption (PKE), cipher, hash/authentication capabilities, decryption, or other capabilities or services. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 742 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as static random-access memory (SRAM), dynamic random-access memory (DRAM), or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

In some examples, OS 732 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others.

In some examples, OS 732 or driver can advertise capability of network interface 750 to query a first memory to determine a subnet of a packet based on a packet identifier and query a second memory to determine routing information based on the subnet and an offset from a start of routing information for the subnet, as described herein. In some examples, OS 732 or driver can enable or disable network interface 750 to query a first memory to determine a subnet of a packet based on a packet identifier and query a second memory to determine routing information based on the subnet and an offset from a start of routing information for the subnet, as described herein.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. In some examples, network interface 750 can refer to one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory.

Some examples of network interface 750 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Some examples of network interface 750 can include a programmable packet processing pipeline with one or multiple consecutive stages of match-action circuitry. The programmable packet processing pipeline can be programmed using one or more of: Protocol-independent Packet Processors (P4), Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), x86 compatible executable binaries or other executable binaries, or others.

In one example, system 700 includes one or more input/output (I/O) interface(s) 760. I/O interface 760 can include one or more interface components through which a user interacts with system 700 (e.g., audio, alphanumeric, tactile/touch, or other interfacing). Peripheral interface 770 can include any hardware interface not specifically mentioned above. Peripherals refer generally to devices that connect dependently to system 700. A dependent connection is one where system 700 provides the software platform or hardware platform or both on which operation executes, and with which a user interacts.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory is memory whose state (and therefore the data stored in it) is indeterminate if power is interrupted to the device. A non-volatile memory (NVM) device is a memory whose state is determinate even if power is interrupted to the device.

In an example, system 700 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Components of examples described herein can be enclosed in one or more semiconductor packages. A semiconductor package can include metal, plastic, glass, and/or ceramic casing that encompass and provide communications within or among one or more semiconductor devices or integrated circuits. Various examples can be implemented in a die, in a package, or between multiple packages, in a server, or among multiple servers. A system in package (SiP) can include a package that encloses one or more of: a switch system on chip (SoC), one or more tiles, or other circuitry.

Communications between devices can take place using a network, interconnect, or circuitry that provides chipset-to-chipset communications, die-to-die communications, packet-based communications, communications over a device interface (e.g., PCIe, CXL, UPI, or others), fabric-based communications, and so forth. A die-to-die communications can be consistent with Embedded Multi-Die Interconnect Bridge (EMIB).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal (e.g., active-low or active-high). The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes one or more examples and includes an apparatus that includes: circuitry for a network interface device, the circuitry configured to determine routing information for a packet by: access a content addressable memory (CAM) to retrieve an Internet Protocol (IP) subnetwork identifier based on a portion of a destination address of the packet; determine a starting memory address of a subnetwork in a memory based on the subnetwork identifier; determine an offset from the starting memory address based on a second portion of the destination address; access the memory to retrieve the routing information for the packet based on the offset and the starting memory address, wherein the routing information comprises an egress port; and cause the packet to be forwarded from the egress port.

Example 2 includes one or more examples, wherein the egress port is to forward the packet to a different subnetwork than a subnetwork of the network interface device.

Example 3 includes one or more examples, wherein the egress port is to forward the packet to a same subnetwork as that of a subnetwork of the network interface device.

Example 4 includes one or more examples, wherein the destination address comprises a destination IP address.

Example 5 includes one or more examples, wherein the second portion of the destination address comprises an offset.

Example 6 includes one or more examples, wherein the determine the starting memory address of the subnetwork in the memory based on the subnetwork identifier and the determine the offset from the starting memory address based on the second portion of the destination address are based on data that translates the subnetwork identifier and the offset into the offset from the starting memory address.

Example 7 includes one or more examples, wherein the network interface device includes one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

Example 8 includes one or more examples, wherein the routing information comprises a sequence of egress ports to traverse and/or a destination network identifier.

Example 9 includes one or more examples, and includes a process of making a forwarding element comprising: connecting a circuitry to an input port and connecting the circuitry to an output port, wherein the circuitry determines routing information of a packet based on retrieving a subnetwork identifier by querying a content addressable memory (CAM) with a portion of a packet identifier and accessing a memory to retrieve the routing information based on the subnetwork identifier and an offset.

Example 10 includes one or more examples, wherein the CAM comprises a ternary content addressable memory (TCAM).

Example 11 includes one or more examples, wherein the portion comprises a number of prefix bits of a destination Internet Protocol (IP) address.

Example 12 includes one or more examples, wherein the retrieving the subnetwork identifier by querying the CAM with the portion of a packet identifier comprises performing a parallel lookup of the CAM based on different lengths of the portion.

Example 13 includes one or more examples, wherein the forwarding element comprises one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

Example 14 includes one or more examples, wherein the packet identifier comprises one or more of: a destination Internet Protocol (IP) address, Ethernet media access control (MAC) address, or InfiniBand local identifier (ID).

Example 15 includes one or more examples, and includes at least one non-transitory computer-readable medium, comprising instructions stored thereon, that if executed by one or more processors, cause the one or more processors to: configure a network interface device to query a first memory to determine a subnet of a packet based on a packet identifier and query a second memory to determine routing information based on the subnet and an offset from a start of routing information for the subnet.

Example 16 includes one or more examples, wherein the first memory comprises a content addressable memory (CAM) or a ternary content addressable memory (TCAM).

Example 17 includes one or more examples, wherein the second memory comprises a static random access memory (SRAM).

Example 18 includes one or more examples, wherein the packet identifier comprises one or more of: a destination Internet Protocol (IP) address, Ethernet media access control (MAC) address, or InfiniBand local identifier (ID).

Example 19 includes one or more examples, wherein the routing information comprises a at least one egress port to forward the packet.

Example 20 includes one or more examples, wherein the network interface device comprises one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

1. An apparatus comprising:
circuitry for a network interface device, the circuitry configured to determine routing information for a packet by:
access a content addressable memory (CAM) to retrieve an Internet Protocol (IP) subnetwork identifier based on a portion of a destination address of the packet;
determine a starting memory address of a subnetwork in a memory based on the subnetwork identifier;
determine an offset from the starting memory address based on a second portion of the destination address;
access the memory to retrieve the routing information for the packet based on the offset and the starting memory address, wherein the routing information comprises an egress port; and
cause the packet to be forwarded from the egress port.

2. The apparatus of claim 1, wherein the egress port is to forward the packet to a different subnetwork than a subnetwork of the network interface device.

3. The apparatus of claim 1, wherein the egress port is to forward the packet to a same subnetwork as that of a subnetwork of the network interface device.

4. The apparatus of claim 1, wherein the destination address comprises a destination IP address.

5. The apparatus of claim 1, wherein the second portion of the destination address comprises an offset.

6. The apparatus of claim 1, wherein the determine the starting memory address of the subnetwork in the memory based on the subnetwork identifier and the determine the offset from the starting memory address based on the second portion of the destination address are based on data that translates the subnetwork identifier and the offset into the offset from the starting memory address.

7. The apparatus of claim 1, wherein the network interface device comprises one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

8. The apparatus of claim 1, wherein the routing information comprises a sequence of egress ports to traverse and/or a destination network identifier.

9. A process of making a forwarding element comprising:
connecting a circuitry to an input port and
connecting the circuitry to an output port, wherein the circuitry determines routing information of a packet based on retrieving a subnetwork identifier by querying a content addressable memory (CAM) with a portion of a packet identifier and accessing a memory to retrieve the routing information based on the subnetwork identifier and an offset.

10. The process of claim 9, wherein the CAM comprises a ternary content addressable memory (TCAM).

11. The process of claim 9, wherein the portion comprises a number of prefix bits of a destination Internet Protocol (IP) address.

12. The process of claim 9, wherein the retrieving the subnetwork identifier by querying the CAM with the portion of a packet identifier comprises performing a parallel lookup of the CAM based on different lengths of the portion.

13. The process of claim 9, wherein the forwarding element comprises one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

14. The process of claim 9, wherein the packet identifier comprises one or more of: a destination Internet Protocol (IP) address, Ethernet media access control (MAC) address, or InfiniBand local identifier (ID).

15. At least one non-transitory computer-readable medium, comprising instructions stored thereon, that if executed by one or more processors, cause the one or more processors to:
configure a network interface device to query a first memory to determine a subnet of a packet based on a packet identifier and query a second memory to determine routing information based on the subnet and an offset from a start of routing information for the subnet.

16. The computer-readable medium of claim 15, wherein the first memory comprises a content addressable memory (CAM) or a ternary content addressable memory (TCAM).

17. The computer-readable medium of claim 15, wherein the second memory comprises a static random access memory (SRAM).

18. The computer-readable medium of claim 15, wherein the packet identifier comprises one or more of: a destination Internet Protocol (IP) address, Ethernet media access control (MAC) address, or InfiniBand local identifier (ID).

19. The computer-readable medium of claim 15, wherein the routing information comprises a at least one egress port to forward the packet.

20. The computer-readable medium of claim 15, wherein the network interface device comprises one or more of: a network interface controller (NIC), a remote direct memory access (RDMA)-enabled NIC, SmartNIC, router, switch, forwarding element, infrastructure processing unit (IPU), data processing unit (DPU), or network-attached appliance.
